(19) United States
(12) Patent Application Publication
(10) Pub. No.: US 2007/0268294 A1
(43) Pub. Date: Nov. 22, 2007

(54) APPARATUS AND METHOD FOR TOPOLOGY NAVIGATION AND CHANGE AWARENESS

(76) Inventors: Stephen Troy Eagen, Rochester, MN (US); Anthony Wayne Erwin, Rochester, MN (US); Timothy Charles Mossing, Rochester, MN (US); Carl Clair Pecinovsky, Rochester, MN (US); Brian Owen Wood, Bryon, MN (US); Michael Vance, Rochester, MN (US)

Correspondence Address: MARTIN & ASSOCIATES, LLC, P.O. BOX 548, CARTHAGE, MO, 64836-0548, US

(21) Appl. No.: 11/383,564

(22) Filed: May 16, 2006

(51) Int. Cl. G06T 15/70

(52) U.S. Cl. 345/474

(57) ABSTRACT

An apparatus and method are described for displaying a topological graph that allows a user to navigate through a history of previous topology displays to increase the user's understanding and awareness of the state of the topology. In a preferred embodiment, a topology display mechanism receives state changes to a topology of a computer network and stores a sequence of graphs that reflect the changes that are made to the topology. The topology display mechanism also allows the user to step through the sequence of stored topology graphs using “video” type controls to change the display of the topology graphs. In other embodiments, the topology display mechanism displays the changes in the topology as a sequence of graphs that form an animation to give the user a graphical visualization of the changes from one topology graph in the sequence to the next.

### BACKGROUND OF THE INVENTION

1. Technical Field

This invention generally relates to topology graphs and more specifically relates to an apparatus and method for navigation and change awareness of a topology graph, and further where the topology graph is used to illustrate the state of computer networks.

2. Background Art

A topology graph is used to display the relationship of a number of inter-related objects. The objects and their relationships can be stored in a computer as nodes and edges. The nodes represent the objects, and the edges represent the relationships. The topology can be displayed on the computer display screen as geometrical shapes to represent the nodes and various lines to represent the edges.

An object may be any data and/or may represent any entity. In one example, objects may be the various computer resources such as hardware devices, software programs, and data that are connected via a computer network, such as clients, servers, routers, storage devices, applications, and databases. The objects are inter-related, e.g., in that a client is connected to a server, a storage device stores a database, and an application uses a database. The topology typically represents the objects via icons displayed on a display screen and represents the relationships via lines between the icons. For example, servers might be represented in the topology via rectangles whose appearances suggest racks of computer components and labels of server names, and the relationships between the servers might be represented by lines that connect the rectangles.

A topology graph can be used to display a large amount of information with many nodes and edges. When the topology display is updated, it can be difficult for the user to recognize and understand the changes. When the topology graph is used to display a computer network topology, if several changes are made or complex changes are made to the display, the user may not see all the changes. Also, the user may want to go back to a previous topology display that represents a previous network condition or time. Without a way to more efficiently navigate and display change to a topology display, topology graph users such as computer administrators will continue to experience difficulty in understanding and visualizing the computer network topology.

### BRIEF SUMMARY OF THE INVENTION

According to the preferred embodiments, an apparatus and method are described for displaying a topological graph in a way that allows a user to navigate through a history of previous topology displays to increase the user's understanding and awareness of the state of the topology. In a preferred embodiment, a topology display mechanism receives state changes to a topology of a computer network and stores a sequence of graphs that reflect the changes that are made to the topology. The topology display mechanism also allows the user to step through the sequence of stored topology graphs using “Video” type controls to change the display of the topology graphs. Further, in other embodiments, the topology display mechanism displays the changes in the topology as a sequence of graphs that form an animation to give the user a graphical visualization of the changes from one topology graph in the sequence to the next.

While the preferred embodiments described herein are directed to topology graphs of a computer network system, the claimed embodiments herein expressly include other topologies that can be displayed on a computer as described herein.

The foregoing and other features and advantages of the invention will be apparent from the following more particular description of preferred embodiments of the invention, as illustrated in the accompanying drawings.

### BRIEF DESCRIPTION OF THE SEVERAL VIEWS OF THE DRAWING(S)

The preferred embodiments of the present invention will hereinafter be described in conjunction with the appended drawings, where like designations denote like elements, and:

FIG. 1 is a block diagram of an apparatus in accordance with a preferred embodiment of the present invention;

FIG. 2 represents a prior art topology display;

FIG. 3 represents another view of a subsequent state of the prior art topology display shown in FIG. 2;

FIG. 4 is a topology display according to preferred embodiments;

FIG. 5 is a topology display according to preferred embodiments;

FIG. 6 is a topology display according to preferred embodiments;

FIG. 7 is a topology display according to preferred embodiments;

FIG. 8 is a topology display according to preferred embodiments;

FIG. 9 is a topology display according to preferred embodiments;

FIG. 10 is a flow diagram for a topology display mechanism to display a topology according to preferred embodiments;

FIG. 11 is another flow diagram for a topology display mechanism to display a topology according to preferred embodiments; and

FIG. 12 is a flow diagram for a topology display mechanism to display a topology according to preferred embodiments.

### DETAILED DESCRIPTION OF THE INVENTION

According to a preferred embodiment of the present invention, an apparatus and method are described for displaying a topological graph in a way that allows a user to navigate through a history of previous topology displays to increase the user's understanding and awareness of the state of the topology.

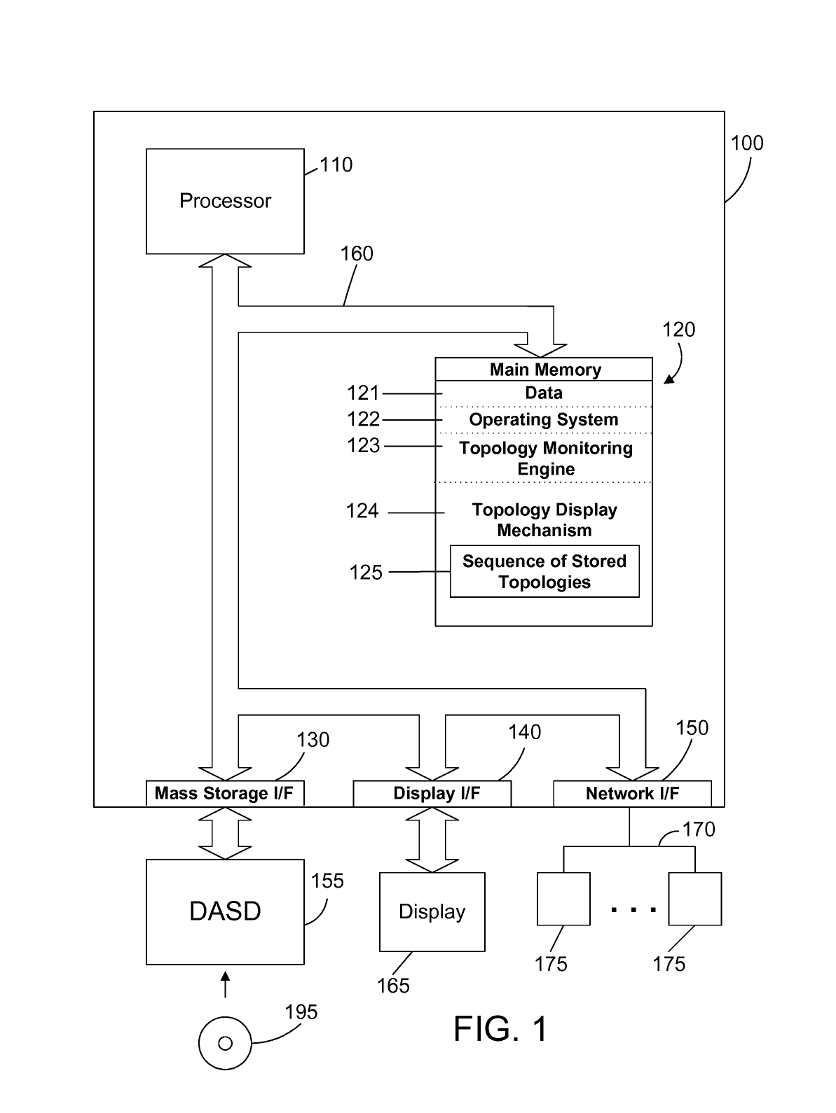

Referring to FIG. 1, a computer system 100 is one suitable implementation of an apparatus in accordance with the preferred embodiments of the invention. Computer system 100 is an IBM System i platform. However, those skilled in the art will appreciate that the mechanisms and apparatus of the present invention apply equally to any computer system, regardless of whether the computer system is a complicated multi-user computing apparatus, a single user workstation, or an embedded control system. As shown in FIG. 1, computer system 100 comprises a processor 110, a main memory 120, a mass storage interface 130, a display interface 140, and a network interface 150. These system components are interconnected through the use of a system bus 160. Mass storage interface 130 is used to connect mass storage devices, such as a direct access storage device 155, to computer system 100. One specific type of direct access storage device 155 is a readable and writable CD RW drive, which may store data to and read data from a CD RW 195.

Main memory 120 in accordance with the preferred embodiments contains data 121, an operating system 122, a topology monitoring engine 123, and a topology display mechanism 124. Data 121 represents any data that serves as input to or output from any program in computer system 100. Operating system 122 is a multitasking operating system known in the industry Linux; however, those skilled in the art will appreciate that the spirit and scope of the present invention is not limited to any one operating system.

The topology monitoring engine 123 is a prior art application program that monitors the topology of a computer network for changes. In preferred embodiments, the changes from the topology monitoring engine 123 are sent to a topology display mechanism 124. In preferred embodiments, the topology display mechanism 124 stores a sequence of graphs or animations that represent a sequence or history of stored topologies 125. Each time the topology display mechanism 124 creates a new topology display in response to input from the topology monitoring engine 123, a display image is stored in the sequence of stored topology images. These elements of preferred embodiments are described further below.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, topology monitoring engine 123, and the topology display mechanism 124 are shown to reside in main memory 120, those skilled in the art will recognize that these items are not necessarily all completely contained in main memory 120 at the same time. It should also be noted that the term “memory” is used herein to generically refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Operating system 122 is a sophisticated program that manages the resources of computer system 100. Some of these resources are processor 110, main memory 120, mass storage interface 130, display interface 140, network interface 150, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiment each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of computer-readable media used to actually carry out the distribution. Examples of suitable computer-readable media include: recordable type media such as floppy disks and CD RW (e.g., 195 of FIG. 1), and transmission type media such as digital and analog communications links. Note that the preferred media is tangible.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

It is also important to point out that the presence of network interface 150 within computer system 100 means that computer system 100 may engage in cooperative processing with one or more other computer systems or workstations on network 170. Of course, this in turn means that the programs and data shown in main memory 120 need not necessarily all reside on computer system 100. For example, one or more portions shown in main memory 120 may reside on another system and engage in cooperative processing with one or more objects or programs that reside on computer system 100. This cooperative processing could be accomplished through use of one of the well known client-server mechanisms such as remote procedure call (RPC).

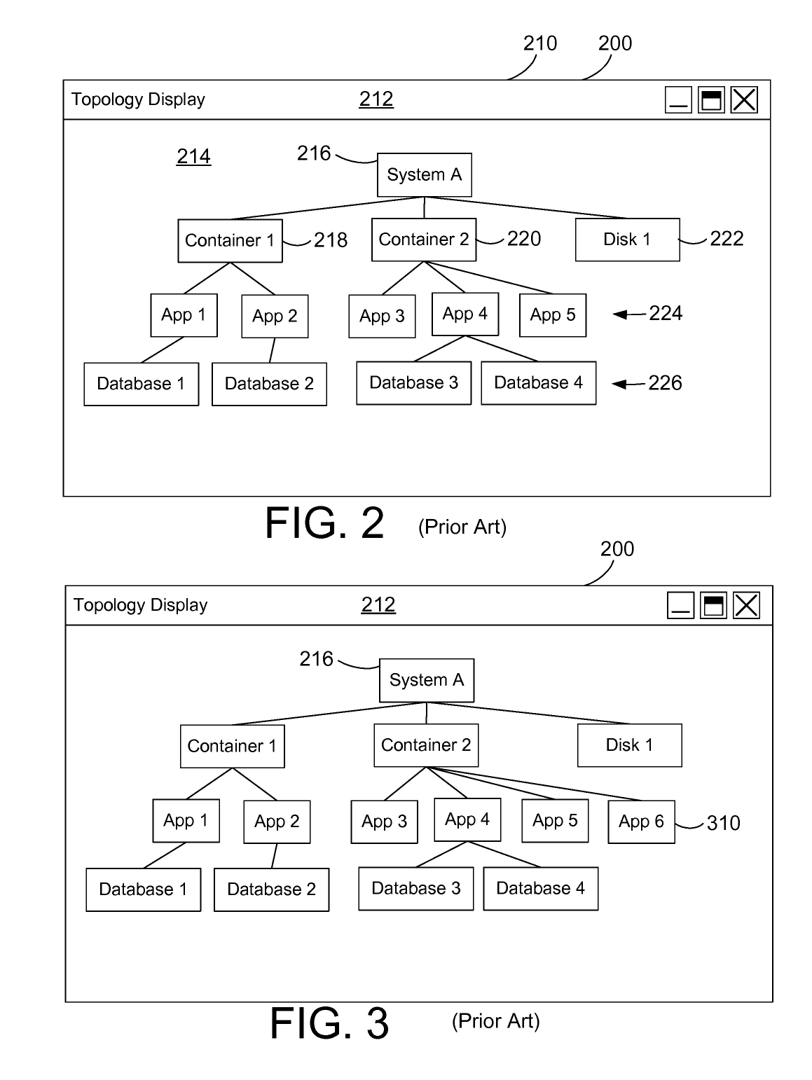

Referring now to FIG. 2, a topology display 200 is illustrated according to the prior art. Topology display 200 is represents a window pane or screen displayed on a computer display 165 (FIG. 1) on computer 100 (FIG. 1). The topology display 200 includes a title bar 212 and a display pane 214. The display pane 214 illustrates a topology for an example System A 216 according to the prior art. Nodes in the topology are represented on the topological display 200 by a geometrical shape (rectangle) and the relationships of the nodes are represented by the lines connecting the nodes. The topology of System A 216 is a hierarchical organization of related objects. The hierarchy objects in System A 216 have a “tree” structure as shown. System A 216 has 3 related objects or nodes, Container 1 218, Container 2 220 and Disk 1 222. Container 1 218 and Container 2 220 contain various applications 224 that are connected to databases 226.

FIG. 3 shows a topology display 200 similar to the topology display 200 illustrated in FIG. 2. FIG. 3 represents the topology display shown in FIG. 2 after a change to the topology has occurred to illustrate limitations of the prior art. In the updated topology display 200 shown in FIG. 2, an additional object, Application 6 310 has been added to Container 2. When a user is given the updated topology display as shown in FIG. 3, it is difficult for the user to recognize and understand what has changed in the display. Further, the user is not able to determine what changes have been made in the recent past and what changes have been made to the topology over a period of time.

The preferred embodiments overcome problems with prior art topology displays by providing topological graphs with highlighted changes to the topology compared to a previous state of the topology. In addition, preferred embodiments allow a user to navigate through a sequence of stored topologies 125 (FIG. 1) that represent the topology at various states in time to increase the user's understanding and awareness of the history and current state of the topology. The sequence of stored topologies may be stored as a graphical image, or a database such as node and edge data that can be reproduced into an image of the topology for display.

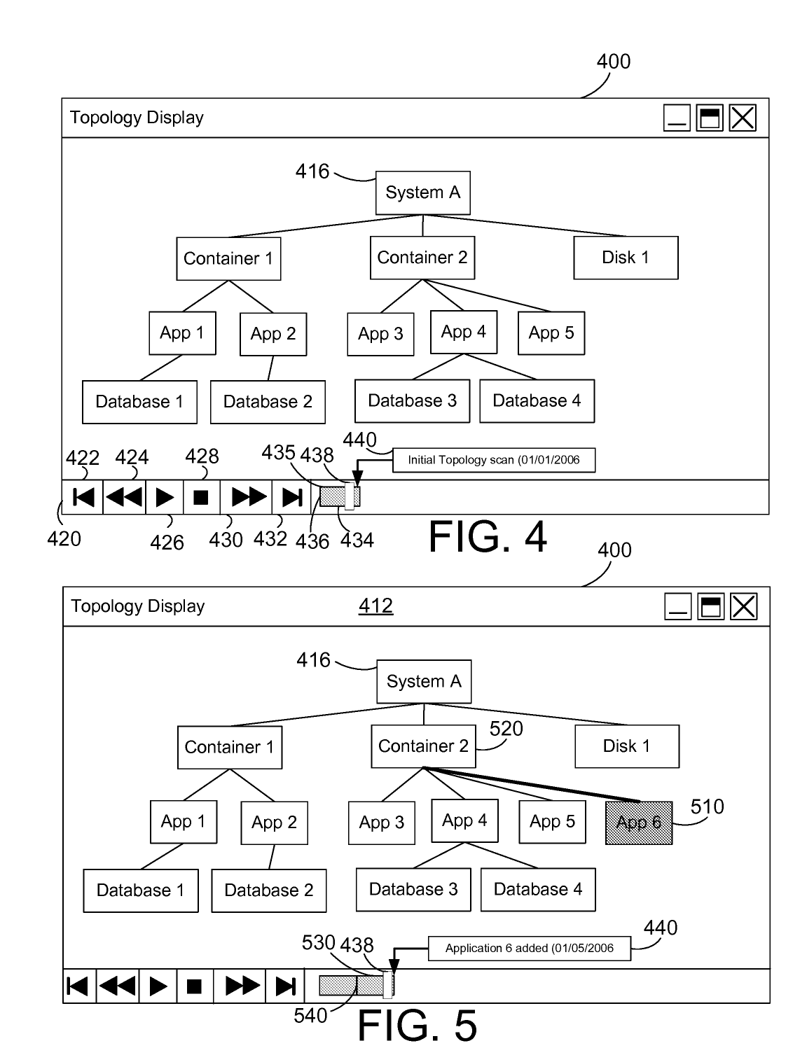

FIG. 4 shows a topology display 400 according to preferred embodiments. Topology display 400 is a topology represented on a computer display similar to the topology display 200 described above with reference to FIG. 2 and FIG. 3. The topology display 400 shows a topology of System A 416 similar to that described above with reference to FIG. 2. System A 416 has a number of related objects in a hierarchal tree as shown. While the preferred embodiments are illustrated with reference to a tree topology, the embodiments expressly include other topology formats known in the art. In preferred embodiments, the topology display mechanism 124 (FIG. 1) creates the topology display 400 as shown in FIG. 4. In addition, the topology display mechanism 124 provides the additional features of the claimed embodiments as described herein.

Topology display 400 includes several “Video” type controls on a control bar 420 to operate the topology display 400 and allow the user to step through a sequence of previously stored topology graphs 125 (FIG. 1). The video controls on the control bar 420 provide a convenient user interface to control the topology display. The Video type controls on the control bar 420 include a jump-to-start button 422, a back button 424, a play button 426, a stop button 428, a fast forward button 430, and a jump-to-end button 432. These buttons operate similar to the corresponding buttons used for many audio and video machines and software, and are sometimes referred to as video controls or “VCR” controls. The control bar further includes a timeline 434 and a position indicator 438. The timeline 434 represents the length of time to replay a number of stored topography display images and in conjunction with the position indicator 438 indicates the location of the current topology display 400 with respect to the overall time of the stored images. The timeline 434 includes a begin tick mark 436 for each unit of the timeline. When the position indicator is placed at the end of a time line unit as shown in FIG. 4, or just before the next begin tick mark, it indicates the topology display is complete for that time line unit. In preferred embodiments, the topology display further includes a flyover text box 440 that gives a textual summary of the current topology display when a pointer or cursor is placed in vicinity of the timeline. In the alternative, the textual summary for the currently displayed change can be displayed all the time as shown in FIG. 4. In FIG. 4, the flyover text box 440 indicates that the topology display 400 represents an initial scan of System A's topology.

FIG. 4 in conjunction with FIGS. 5 through 9 illustrate several features of the preferred embodiments. FIG. 4 represents an initial state of the topology display and subsequent drawings illustrate changes made to the display by the topology display mechanism and in response to user input. The topology in FIG. 4 is created by the topology display mechanism to provide a graphical view of System A's topology in the manner as known in the prior art. The topology display mechanism obtains information to build the topology display from the topology monitoring engine 123 (FIG. 1). The topology monitoring engine 123 obtains an initial scan of the topology of System A 416. The initial scan is used to create the display as shown in FIG. 4 and timeline 434 and position indicator 438 are set to indicate to the user that this is the first topology display image.

FIG. 5 represents the topology of System A 416 after a change in the topology has be received from topology engine and processed by the topology display mechanism. In FIG. 5, the change in the topology of System A 416 is the addition of Application 6 510 (App 6) in Container 2 520. The graphical representation of the node (Application 6) and its relationship edge (the line to Container 2), are highlighted to help the user to easily see the what changes have been made to the topology. A new section 530 is added to the timeline to indicate the additional time added for the change in the topology. A new tick mark 540 is added to the timeline to indicate the beginning of the new entry to the time line. The position indicator 438 is positioned at the end of the timeline to indicate that the change in the topology display is complete. The flyover text box 440 is updated to show a summary of the current change to the topology. In FIG. 5, the flyover text box 440 indicates that the change to the topology is the addition of Application 6 510 on Jan. 5, 2005. The time of the change could also be indicated (not shown).

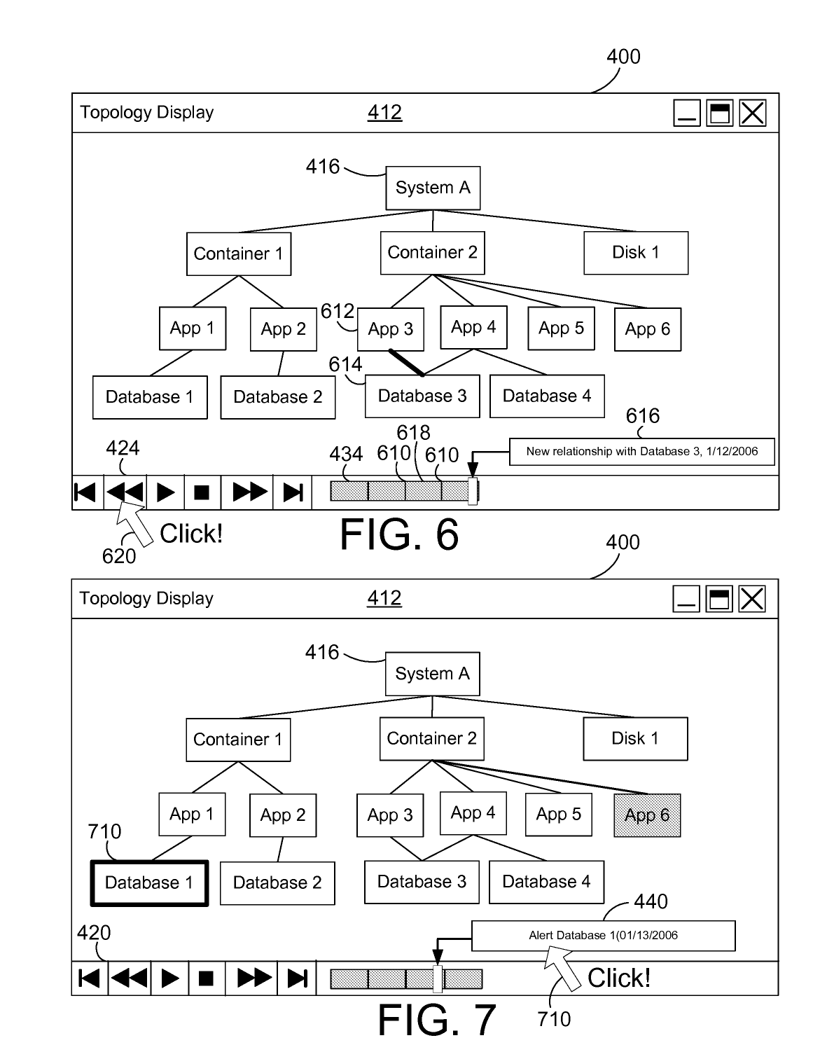

FIG. 6 represents the topology of System A 416 after additional changes in the topology of the system. In this example, the topology has had two additional changes as indicated by the two additional beginning tick marks 610 added to the timeline compared to the topology display shown in FIG. 5. The second change that was made to the timeline is reflected in the current topology display 400. This second change shown in FIG. 6 illustrates another type of change to the topology that can be illustrated by the topology display mechanism. The second changes to the topology is the addition of a new relationship of Application 3 612 with Database 3 614. This new relationship is highlighted to bring the new relationship to the user's attention. The new relationship is also indicated by the summary in the flyover text box 616. The change that occurred to the topology that is indicated by the new beginning tick mark 610 is not apparent from the topology display since the topology display reflects the current state of topology since the position indicator is positioned at the end of the timeline. However, the user is able to observe this previous state of the topology by activating the control buttons. The user can move the topology display back one time unit by clicking on the back button 424 as shown 620.

FIG. 7 represents the state of the topology display subsequent to the user clicking on the back button 424 in FIG. 6. In a similar manner, the user can use the control buttons 420 to move the position cursor to any unit of the timeline to adjust the display to show the corresponding topology in the sequence of stored topology images 125 (FIG. 1).

FIG. 7 shows another feature of the topology display mechanism. In preferred embodiments, the topology display mechanism also displays resource (objects) and relationship health information. When a resource becomes unhealthy, the topology monitor or other system monitor that detects system error sends information regarding the heath issue to the topology display mechanism. A unhealthy status may include situations such as a CPU that exceeds an acceptable utilization percentage, or a resource failure such as a database. When an unhealthy status is received by the topology display mechanism, it creates a new topology display image and a new time unit is added to the timeline. The unhealthy object in the topology is highlighted and the flyover text box 440 indicates the nature of the unhealthy object. In this example, the highlighted object is Database 1 710 and the flyover text box 440 indicates an alert has been issued for Database 1 710.

FIG. 7 illustrates another feature of preferred embodiments. Since topology graphs can become quite large and complex, using the playback mechanism alone to navigate to a particular point in time in the past may not necessarily make it easy to visualize what has changed from one time unit to the next. To give more visual information to show what has changed most recently and what changed further in the past, the intensity of the resource's representation on the topology display can be modified over multiple time periods. Resources that changed in the most recent change transition will be represented with the most intense color or highlighting in the current topology display, while resources that participated in a prior change transition will be slightly less intense and more “grayed”. The intensity of a recently changed resource is transitioned over several time periods, while resources which have not changed in many transitions are represented by a uniform intensity or appearance. This feature is represented in FIG. 7 where the prior change of adding Application 6 510 is shown highlighted, but in a less intense highlighting compared to the previous time unit display shown in FIG. 5.

FIG. 7 also shows an additional feature of the topology display mechanism. In preferred embodiments, the topology display mechanism includes a link to process logs that are related to the change in the status of the topology. For example, in FIG. 7, the topology display indicated that an alert with Database 1 710 has been indicated. When the user clicks 720 on the flyover text box 440, the topology display mechanism displays a process log that includes log data concerning the unhealthy state of Database 1 710. An example of the log data for the alert of Database 1 170 is shown in Table 1 below. In preferred embodiments, the log data displayed by clinking on the flyover text box is by way of a link to log data stored by the topology monitoring engine 123 (FIG. 1) or by some other network monitoring software. The link to the log data could be placed in other places on the topological display, or the log data could be an option of a menu or tool bar (not shown).

TABLE 1
Log data

| Time | Event |
|---|---|
| 01/13/2006 12:53:53 | Database 1: Internal database ‘db1’ failed |
| | consistency check |
| 01/13/2006 12:53:53 | Database 1: Locking access to database ‘db1’ |
| 01/13/2006 12:53:53 | Database 1: Restoring last snapshot of |
| | database ‘db1’ |
| 01/13/2006 12:53:53 | Database 1: Applying journal entries to recover |
| | ‘db1’ . . . |
| 01/13/2006 12:53:54 | Database 1: Starting recovery of ‘db1’ . . . |
| 01/13/2006 12:53:54 | Database 1: Unable to apply journal entries due |
| | to misaligned entries |
| 01/13/2006 12:53:54 | Database 1: Database recovery has failed, access |
| | to ‘db1’ is denied |
| 01/13/2006 12:53:54 | Database 1: Notifying resource |
| | instrumentation of failure |
| 01/13/2006 12:53:55 | Database 1: Message event of failure has been |
| | sent |

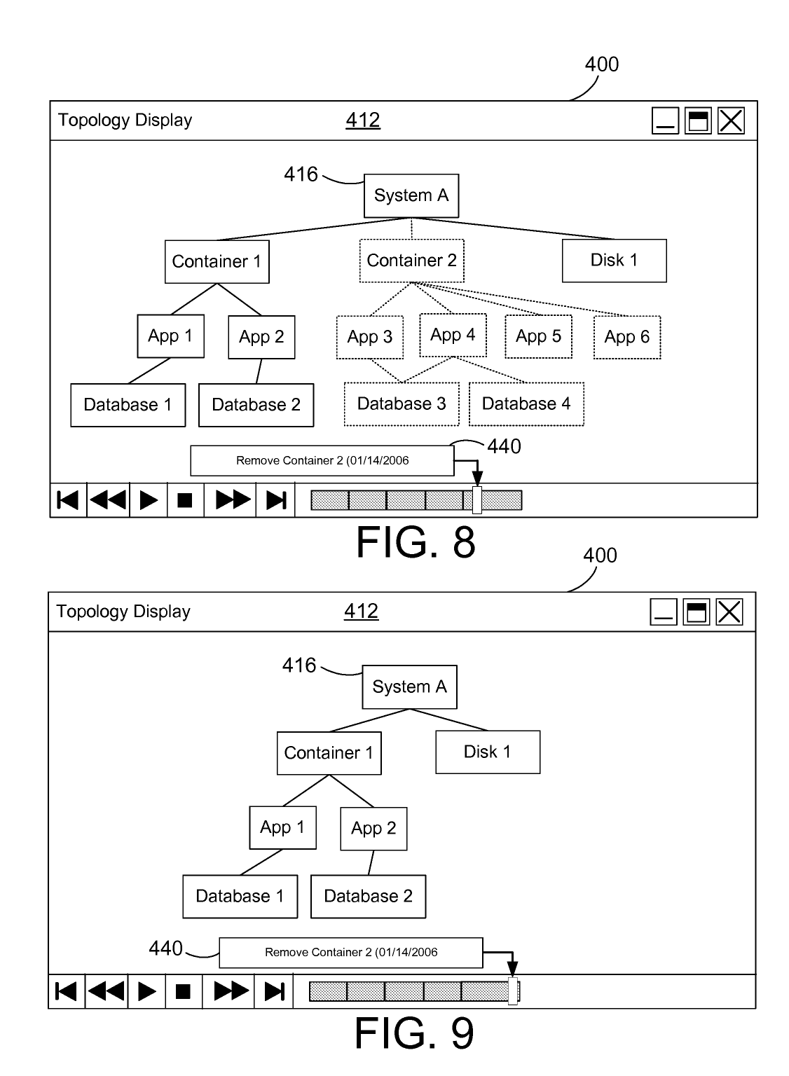

FIGS. 8 and 9 illustrate another preferred embodiment. In this embodiment, the topology display mechanism displays the changes in the topology as a sequence of images that may be shown in sequence as an animation to give the user a graphical visualization of the changes from one topology graph in the sequence to the next. While the above examples were described as though the topology display was a single graphical image, the above description applies equally to this embodiment. Each unit of the timeline represents the time to display the animation. The animation begins at the beginning tick and ends just before the next beginning tick for the next unit or at the end of the timeline. FIGS. 8 and 9 show two views that are snapshots in time as the change in the topology is animated on the display. The change to the topology in these figures is the removal of Container 2 520 (FIG. 7) compared to the topology shown in FIG. 6. The animation begins by fading and then removing Container 2 520 as shown in FIG. 8. The animation is complete after re-arranging the remaining objects in the topology as shown in FIG. 9. In the above examples, the most recent changes are described as being displayed on the topology display for the current location of the position indicator. When animation is included, changes to the topology are shown highlighted during the animation, and when the animation stops, changes for the most recent unit of time on the timeline are highlighted as the “recent changes”. Thus, typically, only those changes for the current unit of time are shown highlighted when the animation is stopped.

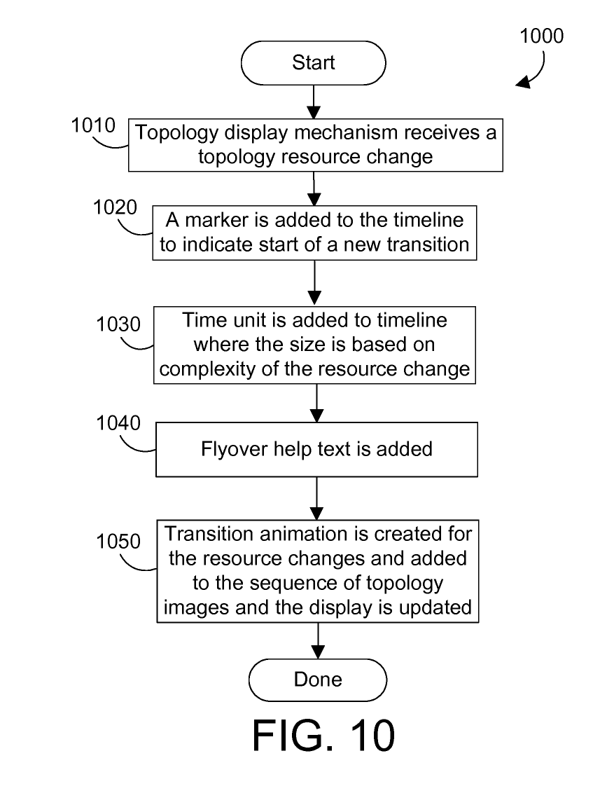

Referring now to FIG. 10, a method 1000 is shown according to preferred embodiments herein. Method 1000 illustrates a method performed by the topology display mechanism 124 to process the changes from the topology monitor engine according to preferred embodiments. The method receives information concerning a topology resource change from the topology monitor engine (step 1010). A tick mark is added to the timeline to indicate the start of a new transition (step 1020). A time unit is added to the timeline where the unit size is based on the complexity of the resource change (step 1030). Flyover text is added the topology display to provide a brief summary of the most recent change to the topology (step 1040). A transition animation is created for the resource changes and the new images of the transition animation are added to the sequence of stored topology images and the display is updated with the new topology image (step 1050). The method is then done.

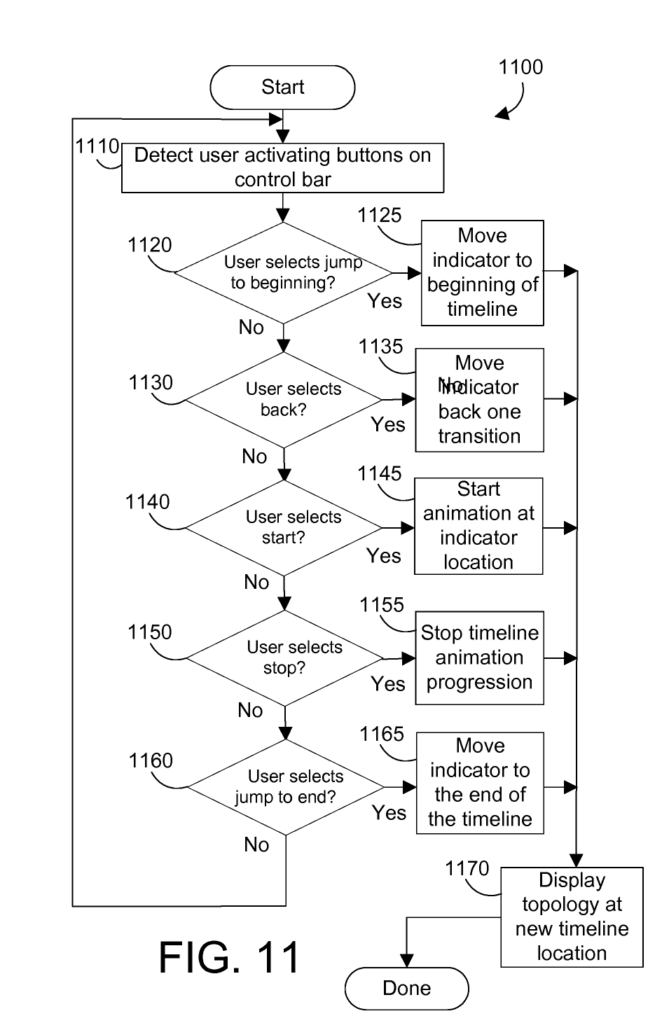

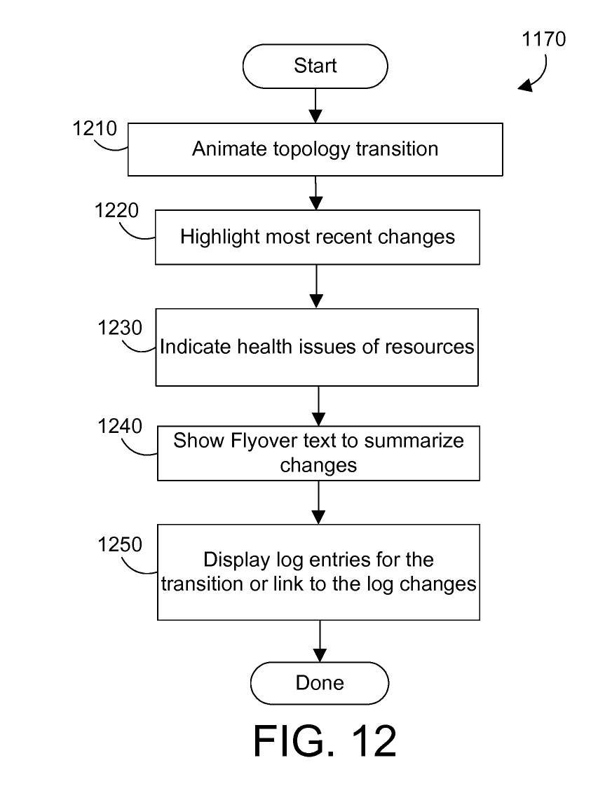

Referring now to FIG. 11, a method 1100 is shown for implementing a portion of functionality of the topology display mechanism according to preferred embodiments herein. In summary, method 1100 determines the input of the user accessing the buttons of the control bar 420 and then updates the topology display at the new time location. The method begins by detecting the user activating buttons on the control bar (step 1110). If the user selects the jump to beginning button (step 1120=yes), then move the position indicator to the beginning of the timeline (step 1125) and display the topology at the new timeline location (step 1170). If the user selects the back button (step 1130=yes), then move the position indicator back one transition (e.g. time unit) on the timeline (step 1135) and display the topology at the new timeline location (step 1170). If the user selects the start button (step 1140=yes), then start the animation at the position indicator location on the timeline (step 1145) and display the topology at the new timeline location (step 1170). If the user selects the stop button (step 1150=yes), then stop the animation at the current location of the position indicator on the timeline (step 1155) and display the topology at the new timeline location (step 1170). If the user selects the jump to end button (step 1160=yes), then move the position indicator to end of the timeline (step 1165) and display the topology at the new timeline location (step 1170). After displaying the topology at the new timeline location (step 1170), the method is done. Step 1170 is further illustrated in FIG. 12 and described below.

Referring now to FIG. 12, a method 1170 is shown as one suitable implementation for step 1170 in FIG. 11 to display the new topology according to preferred embodiments herein. Method 1170 begins by animating the topology transition beginning at the location of the position indicator as selected by the user in method 1100 (step 1210). The most recent changes to the topology are highlighted for the unit of time on the timeline at the position indicator (step 1220). Health issues of resources (topology objects) are indicated on the topology display (step 1230). Flyover text is shown on the topology display to summarize changes for the current unit of time (step 1240). Log entries for the recent transition or error alert are displayed or a link is provided to allow the user to view the log entries (step 1250). The method is then done.

An apparatus and method has been described for displaying a topological graph in a way that allows a user to graphically navigate through a history of previous topology display images. The preferred embodiments provide a way to increase the user's understanding and awareness of the current state of the topology as well as prior states and changes.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

We claim:

1. A computer apparatus comprising:
at least one processor;
a memory coupled to the at least one processor having a plurality of stored topologies, wherein each stored topology represents the state of a topology at a given point in time;
a topology display mechanism in the memory that when executed displays a sequence of the stored topologies controlled by a user interface.

2. The computer apparatus of claim 1 wherein the plurality of stored topologies represent the state of a computer network topology as it changes with time.

3. The apparatus of claim 2 wherein changes to the computer network topology are chosen from the following: adding a new network resource, removing a network resource, adding a new network relationship, removing a network resource, displaying a change in health of a network resource, displaying a change in health of a network relationship.

4. The apparatus of claim 1 wherein the plurality of stored topologies are displayed as controlled by the user with “video” type controls.

5. The apparatus of claim 1 wherein the topology display mechanism further highlights recent changes to the topology.

6. The apparatus of claim 1 wherein topology display mechanism further displays health issues of topology objects.

7. The apparatus of claim 1 wherein topology display mechanism further displays log entries corresponding to the plurality of stored topology images.

8. The apparatus of claim 1 wherein the plurality of stored topologies are displayed as an animation as controlled by the user with “video” type controls.

9. A computer method for displaying a topology, the method comprising the steps of:
(A) receiving a topology change from a topology monitoring engine;
(B) creating a new topology for the topology change; and
(C) storing the new topology with a sequence of stored topologies where the sequence of stored topologies represent various states of the topology at points in time.

10. The method of claim 9 further comprising the steps of:
(C) displaying a set of video type control buttons to the user;
(D) moving a position indicator along a timeline in response to the user selecting the video type control buttons; and
(E) displaying the topology corresponding to the new location of the position indicator on the timeline.

11. The method of claim 10 where in the step of displaying the topology corresponding to the new location of the position indicator on the timeline comprises the step of highlighting the most recent changes.

12. The method of claim 10 where in the step of displaying the topology corresponding to the new location of the position indicator on the timeline comprises the step of indicating health issues of a topology object.

13. The method of claim 12 where in the step of displaying the topology corresponding to the new location of the position indicator on the timeline comprises the step of displaying log entries corresponding the health issue.

14. A computer readable program product comprising:
a topology display mechanism that when executed displays a plurality of stored topologies controlled by a user interface, wherein each stored topology represents the state of a topology at a given point in time; and
recordable computer media bearing the topology display mechanism.

15. The program product of claim 14 wherein the plurality of stored topology images represent the state of a computer network topology as it changes with time.

16. The program product of claim 15 wherein changes to the computer network topology are chosen from the following: adding a new network resource, removing a network resource, adding a new network relationship, removing a network resource, displaying a change in health of a network resource, displaying a change in health of a network relationship.

17. The program product of claim 14 wherein the topology display mechanism further highlights recent changes to the topology.

18. The program product of claim 14 wherein topology display mechanism further displays health issues of topology objects.

19. The program product of claim 14 wherein topology display mechanism further displays log entries corresponding to a topology image of the sequence of stored topology images.

20. A method for deploying computing infrastructure, comprising integrating computer readable code into a computing system, wherein the code in combination with the computing system is adapted to perform the method of claim 1.
